(19) United States
(12) Patent Application Publication
(10) Pub. No.: US 2024/0311821 A1
(43) Pub. Date: Sep. 19, 2024

(54) BLOCKCHAIN BLOCKS & PROOF-OF-EXISTENCE

(71) Applicant: nChain Licensing AG, Zug (CH)

(72) Inventors: Jack Owen DAVIES, London (GB); Michaella PETTIT, London (GB); Sigourney HOVE, London (GB); Craig Steven WRIGHT, London (GB)

(21) Appl. No.: 18/578,249

(22) PCT Filed: Jun. 14, 2022
(86) PCT No.: PCT/EP2022/066080

§ 371 Date: Jan. 10, 2024

(30) Foreign Application Priority Data
Jul. 14, 2021 (GB) 2110112.6

(51) Int. Cl. G06Q 20/38; G06Q 20/40

(52) U.S. Cl. CPC G06Q 20/389; G06Q 20/401

(57) ABSTRACT

A computer-implemented method of constructing a candidate block of a blockchain, wherein the method comprises: obtaining a set of blockchain transactions; obtaining a transaction representation by inputting each of the set of blockchain transactions to a Bloom filter that utilizes one or more hash functions; and constructing the candidate block, wherein the candidate block comprises the transaction representation.

### CROSS REFERENCE TO RELATED APPLICATIONS

This application is the U.S. National Stage of International Application No. PCT/EP2022/066080 filed on Jun. 14, 2022, which claims the benefit of United Kingdom Patent Application No. 2110112.6, filed on Jul. 14, 2021, the contents of which are incorporated herein by reference in their entireties.

### TECHNICAL FIELD

The present disclosure relates to a method of constructing blockchain blocks and to a method of performing a proof to determine whether a target blockchain transaction exists in a blockchain block.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

In classical implementations of blockchains, such as Bitcoin, Litecoin, and Ethereum, it is common to find a Merkle tree used in at least some aspect of the implementation. The prevalence of Merkle trees in blockchain design can be attributed to the fact that these designs generally aim to maximise transactional throughput in the system. The use of Merkle trees for compact data representation in these systems is therefore a natural choice because the computational complexity of computing Merkle proofs of existence scales as O(log n) with the total number of elements n in the data set represented by the Merkle tree. In the case of blockchain systems, n can be taken as the number of transactions contained in a single block of the blockchain and, assuming a steady-state, can be taken as a constant corresponding to the transaction throughput of the blockchain. The construction of a Merkle tree for a large number of elements is also considered to be highly efficient, given that the number of layers of the binary tree also scale as O(log n).

Conversely, the applicability of Merkle trees to alternative blockchain systems where n is intended to be small is significantly different. In fact, for blockchains with small n-per block by design, the use of a Merkle tree to represent the set of transactions in a block may add unnecessary computational overhead due to the computation of the Merkle tree itself. This issue may be exacerbated further in such blockchains where the frequency f of block production is very high (e.g. much greater than 10 minutes), as this additional overhead will be encountered for each block which increases the overall operational expenditure of a blockchain validator.

It would therefore be desirable to use an alternative, more efficient representation of the set of transactions that make up a block of the blockchain. A more efficient transaction representation would provide for a low-burden blockchain architecture, which can be used as the basis for blockchain systems with both low n and high f. A more efficient transaction representation would achieve the property that the blockchain is ‘low-burden’ by design for both validators and users.

According to one aspect disclosed herein, there is provided a computer-implemented method of constructing a candidate block of a blockchain, wherein the method comprises: obtaining a set of blockchain transactions; obtaining a transaction representation by inputting each of the set of blockchain transactions to a Bloom filter that utilizes one or more hash functions; and constructing the candidate block, wherein the candidate block comprises the transaction representation.

A block constructor, or block producer (e.g. a blockchain node), obtains a set of transactions, e.g. from users of other block producers. The transactions may be taken from a pool of transactions waiting to be placed into a new blockchain block. Rather than using a Merkle root to represent the transaction set, the block producer represents the transaction set using a Bloom filter. That is, the block producer supplies each of the hash functions associated with the Bloom filter, and maps the outputs to the Bloom filter. Once each transaction has been hashed using the hash function(s), the final state of the Bloom filter is used as a transaction representation and placed in the candidate block. As will be appreciated by the skilled person, the final state of the Bloom filter is an array (i.e. a data structure), where each cell of the array takes one of two possible values (e.g. zero of one), where the value of any given cell is determined by said hashing of the transactions. The candidate block may then be submitted to the blockchain network for validation by nodes of the network.

According to one aspect disclosed herein, there is provided a computer-implemented method of determining whether a block of a blockchain comprises a target blockchain transaction, wherein the block comprises a transaction representation obtained by inputting each of a set of blockchain transactions to a Bloom filter that utilizes one or more hash functions, and wherein the method comprises: obtaining the target blockchain transaction; obtaining a target representation of the target blockchain transaction by inputting the target blockchain transaction to each of the one or more hash functions utilized by the Bloom filter; and determining whether the block comprises the target blockchain transaction based on a comparison of the transaction representation and the target representation.

A Bloom filter is a data structure designed to enable one to determine, rapidly and memory-efficiently, whether an element is present in a set. According to the present disclosure, a Bloom filter is used to prove whether a transaction exists as part of a set of transactions that make up a blockchain block. A verifying user wishes to determine whether a target transaction (e.g. received from a different user) exists on the blockchain. The verifying user obtains the target transaction and a transaction representation (i.e. final state of a Bloom filter) for a given block, i.e. a block purported to contain the target transaction. The verifying user hashes the target transaction with the hash functions associated with the Bloom filter. If the outcome of the hashing results in the same set of cells being “turned on” or “activated” (i.e. taking a particular value, e.g. one) as the corresponding set of cells in the final state of the Bloom filter (the transaction representation), then the verifying user can be confident that the target transaction exists in the block. If any of the set of cells that are activated after hashing the target transaction are not also activated in the transaction representation, then the target transaction is definitely not present in the block.

In other words, to test for membership of the target transaction, the verifying user hashes the target transaction with the same hash functions used to generate the transaction representation, then checks whether the resulting values are also are set in the transaction representation. If they aren't, the target transaction isn't in the block. If they are, the target transaction might be in the set, however, another transaction or some combination of other transaction could have set the same values.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 schematically illustrates an example Merkle tree,

FIG. 6 schematically illustrates a Merkle proof-of-existence of a data block in a Merkle tree represented by a Merkle root using a Merkle path,

FIG. 7 schematically illustrates an example system for implementing the described embodiments, and

FIG. 8 schematically illustrates an example Bloom filter.

### DETAILED DESCRIPTION OF EMBODIMENTS

### 1. Example System Overview

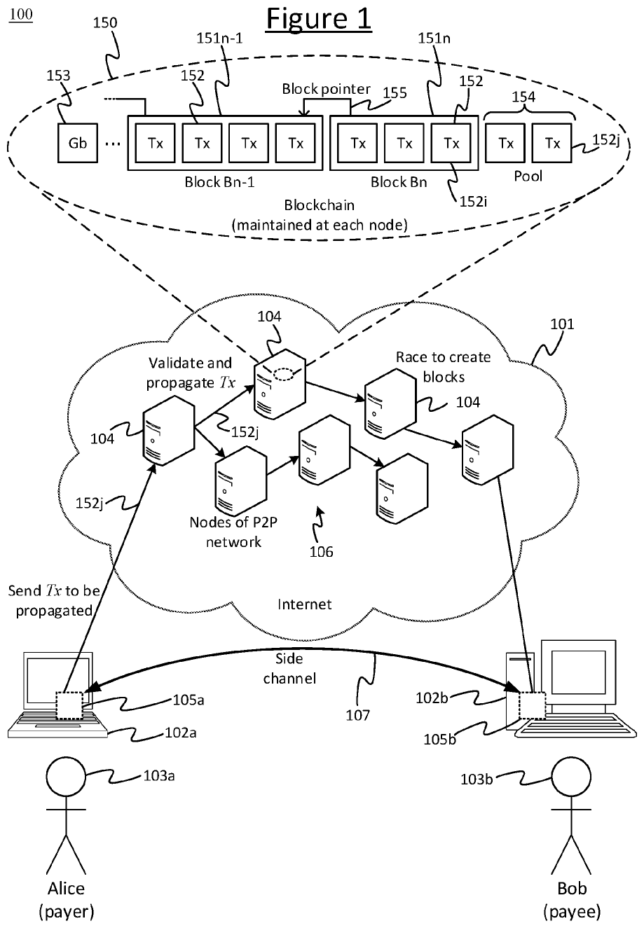

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

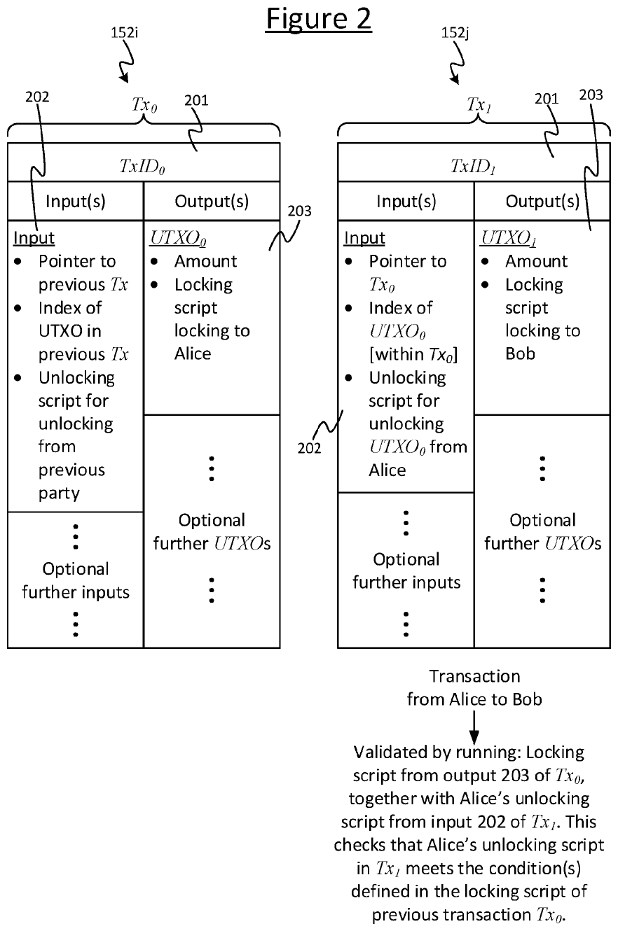

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
   where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Client Software

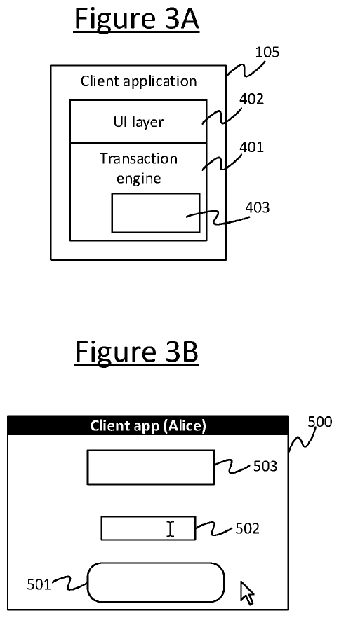

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 5. Node Software

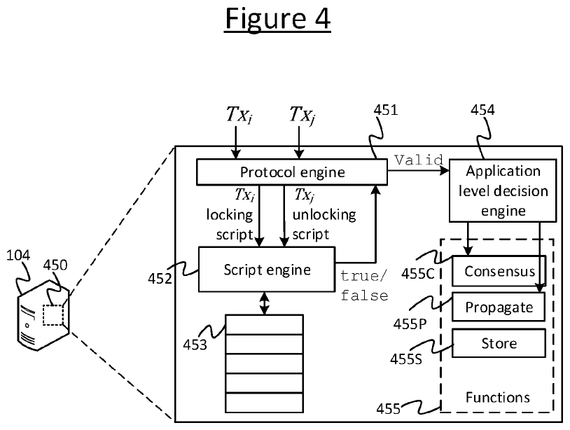

FIG. 4 illustrates an example of the node software 450 that is run on each blockchain node 104 of the network 106, in the example of a UTXO-or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 6. Merkle Trees

A common method for representing large quantities of data in an efficient and less resource-intensive way is to store it in structure known as a hash tree, where a hash is taken to mean the digest of a one-way cryptographic hashing function such as SHA-256. It is not necessary go into full descriptions of hash functions here, but it should be appreciated that a typical hash function takes an input of arbitrary size and produces an integer in a fixed range. For example, the SHA-256 hash function gives a 256-bit number as its output hash digest.

In general, a hash tree is a tree-like data structure comprising internal nodes and leaf nodes. Each leaf represents the cryptographic hash of a portion of data that is to be stored in the tree, and each node is generated by hashing the concatenation of its children. The root of the hash tree can be used to represent a large set of data compactly, and it can be used to prove that any one of the portions of data corresponding to a leaf node is indeed part of the set.

In many applications, binary hash trees are used in which every non-leaf node has exactly two children and leaf nodes are the hash of a portion of data. For instance, the bitcoin blockchain uses a binary hash tree implementation—a Merkle tree—to store all the transactions for a block compactly. The root hash is stored in the block header to represent the full set transactions included in a block.

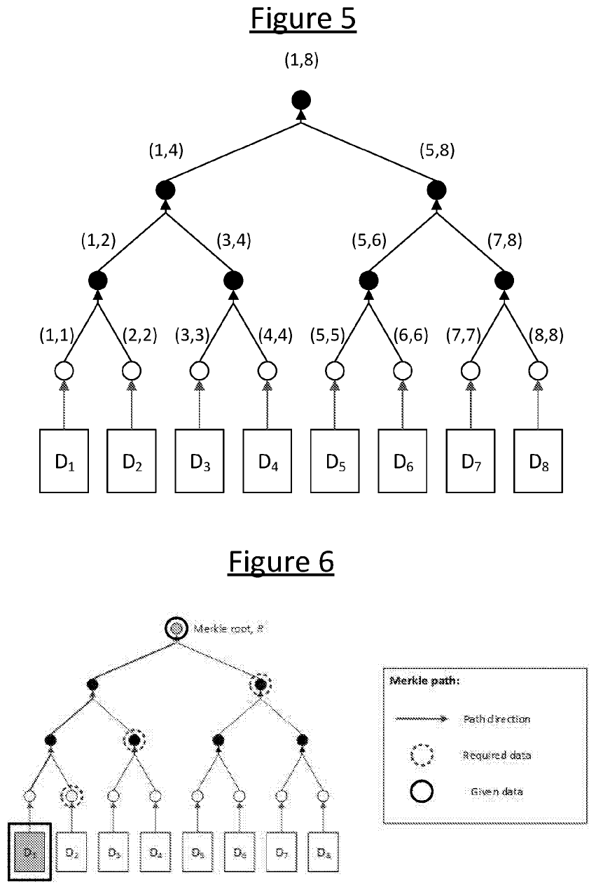

The structure of a binary hash tree is shown in FIG. 5, where arrows represent the application of a hash function, white circles represent leaf nodes and black circles are used both for internal nodes and the root.

This hash tree stores a set of eight portions of data D₀ . . . D₇ by hashing each portion and concatenating the resulting digests pairwise H(D₀)∥H(D₁), . . . , H(D₆)∥H(D₇), where the ‘∥’ operator denotes the concatenation of two strings of data. The concatenated results are then hashed, and the process repeated until there is a single 256-bit hash digest remaining—the Merkle root—as a representation of the entire data set.

The Merkle tree is the original implementation of a hash tree, proposed by Ralph Merkle in 1979, which is typically interpreted as a binary hash tree. Note that a Merkle tree may also be non-binary. In a Merkle tree, each node in the tree has been given an index pair (i, j) and is represented as N(i, j). The indices i, j are simply numerical labels that are related to a specific position in the tree.

An important feature of the Merkle tree is that the construction of each of its nodes is governed by the following equations

$$N ( i , j ) = \{ \begin{matrix}H ( {D}_{i} ) & i = j \\ H ( N ( i , k ) \vert \vert N ( k + 1 , j ) ) & i \neq j\end{matrix} .$$

As shown in FIG. 5, the i=j case corresponds to a leaf node, which is simply the hash of the corresponding i^{th} piece of data Dᵢ. The i≠j case corresponds to an internal or root node, which is generated by recursively hashing and concatenating child nodes in the tree until the specific node or the root is reached.

For example, the node N(0,3) is constructed from the four data pieces D₀, . . . , D₃ as

$$\begin{matrix}N ( 0 , 3 ) = H ( N ( 0 , 1 ) \vert \vert N ( 2 , 3 ) ) \\ = H [ H ( N ( 0 , 0 ) \vert \vert N ( 1 , 1 ) ) \vert \vert H ( N ( 2 , 2 ) \vert \vert N ( 3 , 3 ) ) ] \\ = H [ H ( H ( {D}_{0} ) \vert \vert H ( {D}_{1} ) ) \vert \vert H ( H ( {D}_{2} ) \vert \vert H ( {D}_{3} ) ) ] .\end{matrix}$$

The primary function of a Merkle tree in most applications is to facilitate a proof that some piece of data Dᵢ is a member of a list or set of N data [symbol] ∈{D₁, . . . , D_{N}}. Given a Merkle root and a candidate portion of data Dᵢ, this can be treated as a ‘proof-of-existence’ of the block within the set.

The mechanism for such a proof is known as a Merkle proof and comprises obtaining a set of hashes known as the Merkle path for a given piece of data Dᵢ and Merkle root R. The Merkle path for a piece of data is simply the minimum list of hashes required to reconstruct the root R by way of repeated hashing and concatenation, often referred to as the ‘authentication path’ for a piece of data.

The method for validating a Merkle proof is to take the proof, which is simply a set of hashes (nodes in the Merkle tree) and successively hash and concatenate them in sequence, starting from the leaf hash the proof applies to. This process of starting with a leaf and successively hashing and concatenating with other hashes is effectively moving up the Merkle tree until we have a calculated root. At this point, we simply check that the calculated root is equal to the known root, which should be trusted and known previously. If, given a Merkle root R, we wish to prove that the data D₀ belongs to the set [symbol] ∈{D₀, . . . , D₇} represented by R we can perform a Merkle proof as follows:
i. Obtain the Merkle root R from a trusted source.
ii. Obtain the Merkle path Γ from a source. In this case, Γ is the set of hashes:

$$Γ = \{ N ( 1 , 1 ) , N ( 2 , 3 ) , N ( 4 , 7 ) \} .$$

iii. Compute a Merkle proof using D₀ and Γ as follows:
   a. Hash the data to obtain:

$$N ( 0 , 0 ) = H ( {D}_{0} ) .$$

b. Concatenate with N(1,1) and hash to obtain:

$$N ( 0 , 1 ) = H ( N ( 0 , 0 ) \vert \vert N ( 1 , 1 ) ) .$$

c. Concatenate with N(2,3) and hash to obtain:

$$N ( 0 , 3 ) = H ( N ( 0 , 1 ) \vert \vert N ( 2 , 3 ) ) .$$

d. Concatenate with N(4,7) and hash to obtain the root:

$$N ( 0 , 7 ) = H ( N ( 0 , 3 ) \vert \vert N ( 4 , 7 ) ) ,$$

$${R}^{′} = N ( 0 , 7 ) .$$

e. Compare the calculated root R′ with the root R obtained in (i):
   I. If R′=R, the existence of D₀ in the tree, and therefore the data set [symbol] , is confirmed.
   II. If R′≠R, the proof has failed and D₀ is not confirmed to be a member of [symbol] .

This is an efficient mechanism for providing a proof-of-existence for some data as part of the data set represented by a Merkle tree and its root. For example, if the data D₀ corresponded to a blockchain transaction and the root R is publicly available as part of a block header then we can

The process of authenticating the existence of D₀ as part of our example Merkle tree is shown in FIG. 6. This demonstrates that performing the Merkle proof for a given data D₀ and root R is effectively traversing the Merkle tree ‘upwards’ by using only the minimum number of hash values necessary.

There are various overheads associated with computing Merkle proofs of existence which must be incurred when validating a transaction in Bitcoin-like blockchains, since proving that a transaction has been included in a block requires computational validation of a Merkle proof using a candidate Merkle path.

We can quantify the following computational and storage overheads associated with Merkle proofs:
Computational complexity of proofs, C_{Γ}
Average proof size, M= [symbol] |Γ| [symbol] . In a binary Merkle tree, the proof size is the same for all elements in the set.
Total size of the Merkle tree.

The following table illustrates the relationship between the number of leaf nodes in a Merkle tree and the number of hashes required for a Merkle proof.

| | | | | | | | General formula |
|---|---|---|---|---|---|---|---|
| No. data pieces | 2 | 4 | 8 | 32 | 64 | 256 | n = 2^{M} |
| No. hashes required | 1 | 2 | 3 | 5 | 6 | 8 | M = log₂ n |
| for proof-of-existence | | | | | | | |

### 7. Operational Costs of Bitcoin

There are several operational costs and overheads associated with running a Bitcoin node, which may also apply generally to a wide range of popular blockchain implementations.

A summary of the recommended operational requirements for running a Bitcoin SV node at the time of writing is given in the following table, listed for a development environment as well as minimum and recommended requirements for a production environment.

| | Development | Production (min.) | Production (rec.) |
|---|---|---|---|
| Processor | 4 core, 8 thread | 8 core, 16 thread | 10 core, 20 thread |
| (validation) | CPU | CPU | CPU+ |
| Memory | 6 GB RAM + 10 GB | 64 GB RAM + 64 GB | 64 GB RAM + 64 GB |
| (validation) | Swap | Swap | Swap |
| Internet | 10 + Mbit (up/down) | 100 + Mbit | 1 + GBit (up/down) |
| (propagation) | | (up/down) | |
| Disk space | Full: 1 TB | Full: 1 TB | Full: 1 TB |
| (storage) | Pruned: 100 GB | Pruned: 100 GB | Pruned: 100 GB |

In order to be a competitive miner, there are additional hardware requirements and operational costs, such as electricity for hashing and general maintenance, which are unrelated to transaction processing. At the time of writing, a typical competitive miner will expect to have on the order of 10 EH/s at their disposal.

The operational costs associated with running a Bitcoin node have been the cause of widespread debate in the industry, as these requirements are related to the scalability of the system.

To summarise the debate, one philosophy argues that blockchains such as BTC should retain small block sizes with small n per block, so as to minimise the operational cost of running the node. This means that anybody may run the Bitcoin client software, even if they do not compete as a node on the network, where the definition of a ‘node’ includes creation and publishing of new blocks. This philosophy is generally referred to as ‘layer-2 scaling’ as it implies solutions must exist at a layer above the base blockchain to facilitate high transactional throughput overall.

The second philosophy argues that blockchains such as BSV should have unrestricted block sizes, which allow for much larger transaction throughput by having a large n per block. This comes at an increased cost in terms of transaction processing for node operators, meaning fewer entities will be able to run nodes. This approach to scaling is generally referred to as ‘big block scaling’ as it implies the bulk of transactional throughout in the system can be achieved by a block size that is free to expand at the behest of Bitcoin nodes.

Note that whilst described in terms of the Bitcoin blockchain, the above discussion similarly applies to other blockchain implementations.

### 8. Block Production & Proof of Existence

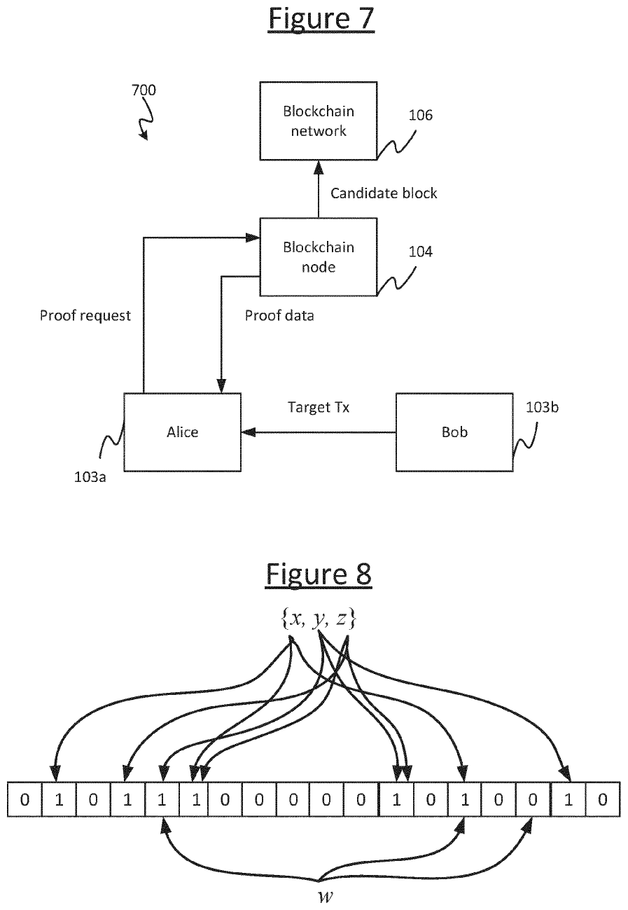

FIG. 7 shows an example system 700 for implementing embodiments of the present disclosure. The system 700 comprises one or more parties, e.g. users such as Alice 103a and Bob 103b. Note that “parties” here is meant in the general sense and includes both users and machines. For conveniences, the parties will be referred to below as Alice 103a and Bob 103b, but it should be appreciated that the parties of the system 700 do not necessarily have to be configured to perform all of the operations described as being performed by Alice 103a and Bob 130b with reference to FIGS. 1 to 3, although that is one possibility. Note also that some embodiments only involve a single party, who will be referred to as Alice 103a. In these embodiments, Alice 103a takes the role of a verifying party—a party that wishes to verify that a transaction exists on a blockchain. Bob 103b may take the role of a party that sends/receives a transaction to/from Alice 103a. The roles of Alice 103a and Bob 103b are discussed more below.

The system 700 also comprises a blockchain network 106. A blockchain node 104 is shown separately from the blockchain network 106 in FIG. 7, but it should be understood that the blockchain node 104 is a part of the blockchain network 106. The blockchain node 104 may also be referred to as a block producer or a block constructor. Note also that the blockchain node 104 need only be configured to perform the operations described below, and not necessarily all those described as being performed by the blockchain node 104 with reference to FIGS. 1 to 4, although that is certainly one implementation.

Embodiments of the present disclosure provide for an alternative, more efficient process of constructing (i.e. producing) blocks of a blockchain. The process is made more efficient by not representing the set of transactions that make up the block using a Merkle tree, as is typically the case with current blockchains. Instead, the blockchain node 104 is configured to use a Bloom filter to represent the set of transactions.

The blockchain node 104 obtains a set of transactions that are to be included in a candidate block. The block is only a candidate block at this point because it has not yet been submitted to and validated by the blockchain network 106. One, some or all of the transactions may have been received directly from users, e.g. Alice 103a and Bob 103b. Additionally, or alternatively, one, some or all of the transactions may have been received from other nodes of the blockchain network 106. One of the set of transactions may be a coinbase (or generation) transaction that assigns new coins (i.e. the underlying digital asset of the blockchain) to the blockchain node should the candidate block be validated by the network 106.

The blockchain node 104 then generates a “transaction representation”, i.e. data representing the set of transactions that make up the candidate block. In this case, the transaction representation is a data structure in the form of a Bloom filter. The skilled person will be familiar with Bloom filters per se. See www.di-mgt.com.au/bloom-filter.html for a description of Bloom filters. A Bloom filter comprises an array (e.g. a bit vector) of values, where each value can either take a 1 or a 0. A transaction is hashed with one or more hash functions, and the output is represented by (i.e. mapped to) one or more bits in the bit vector. In other words, the output of the hashing will set one or more of the values of the vector to 1, whilst leaving the remaining values as 0.

As is known in the art, a Bloom filter is parameterised by one or more hash functions. The number of hash functions is normally denoted by k. A Bloom filter is probabilistic in the sense that it can produce false positives. False negatives are not possible. The probability of a false positive occurring is dependent on k, and therefore the blockchain node 104 may choose to adapt k so as to adapt the probability. Rather than being set by the blockchain node 104, k may be set by the blockchain protocol. Similarly, the type of hash functions utilised by the blockchain node 104 to hash each transaction (e.g. SHA-2, SHA-256, SHA-512, etc., Murmur hash, etc.) may be chosen by the blockchain node 104 or set by the protocol. One, some or all of the hash functions may be cryptographic hash functions.

Once each of the set of transactions has been hashed with the k hash functions and the output mapped to the Bloom filter, the final state of the Bloom filter is taken as the transaction representation. The transaction representation is included in the candidate block.

The candidate block may then be submitted to the blockchain network 106, e.g. for validation. Note that in some examples the candidate block is not submitted to the network 106, e.g. because a different, valid candidate block produced by a different node 104 has been submitted to the blockchain network 106. The skilled person will be aware of what it means for a candidate block to be validated by a blockchain network. For instance, a valid block may be one which includes a solution to a proof-of-work puzzle, or it may be one which has been voted as valid by a minimum number of nodes 104.

In some embodiments, the candidate block comprises the set of transactions represented by the transaction representation. However that is not essential in all embodiments, and instead the set of transactions may be recorded elsewhere, e.g. in an off-chain database. The transaction representation serves as proof that the transactions exist.

The candidate block may comprise a block header that is used to chain (i.e. link) successive blocks of the blockchain. Again, the skilled person will be familiar with the notion of chaining blocks via their block headers. For instance, in a proof-of-work blockchain, a hash of the block header (a “block header hash”) of the current (candidate) block must satisfy a difficulty target (e.g. have a certain number of leading zeros) in order for the block to be deemed valid. The block header typically comprises a hash of the block header of the previous block and a nonce value. The nonce value is adapted so as to adapt the block header hash until a valid solution to the proof-of-work puzzle is found.

The blockchain node 104 may construct a plurality of candidate blocks in this way, each candidate block being based on a different respective set of transactions, and therefore comprising a different respective transaction representation.

The blockchain node 104 may validate other candidate blocks, i.e. candidate blocks submitted to the network 106 by different nodes 104. Validating a candidate block may comprise obtaining the respective set of transactions purported to belong to the candidate block, and hashing each transaction with k hash functions so as to populate a Bloom filter. If the transaction representation included in the candidate block matches the Bloom filter generated by the blockchain node, then the transaction representation is deemed valid. The candidate block may have to satisfy other conditions in order for the candidate block as a whole to be deemed valid.

As mentioned above, the system 700 comprises a verifying party, Alice 103a. Alice 103a wishes to verify that a target transaction exists on the blockchain. More specifically, Alice 103a wishes to verify that the target transaction exists within a block of the blockchain, where that block comprises a transaction representation generated as described above. Alice 103a obtains the transaction, e.g. from Bob 103b, or from a blockchain node 104, or elsewhere, e.g. directly from the blockchain. Alice 103a may be a merchant, and Bob 103b may be a customer attempting to pay for goods or services using an output of the target transaction. Note that this is merely an illustrative example and in general the described embodiments may be used in any setting, not just a commercial transaction.

To verify whether the target transaction exists in a target block (also referred to as performing a proof-of-existence) Alice 103a generates a target representation of the target transaction. Note that Alice 103a generates a representation of the target transaction only, and not the set of transactions represented by the target block as a whole. To generate the target representation of the target transaction, Alice 103a hashes the target transaction with the one or more hash functions that parameterise the Bloom filter used by the blockchain node 104 to generate the transaction representation. Having hashed the target transaction, one or more values of the data structure (Bloom filter) will be set to 1. Alice 103a compares the Bloom filter that she has produced with the transaction representation from the target block. If any of the values set to 1 in her Bloom filter are not set to 1 in the transaction representation, then Alice 103a can be certain that the target transaction is not represented by the transaction representation and therefore is not represented (e.g. does not exist) as part of the target block. On the other hand, if all of the values set to 1 in her Bloom filter are also set to 1 in the transaction representation, then Alice 103a can be confident (but not certain) that the target transaction is represented by the transaction representation and therefore by the target block.

Alice 103a may obtain the transaction representation from the blockchain node 104 (e.g. the node that generated the candidate block comprising the transaction representation) or from a different node of the network 106. For example, Alice 130a may submit a request to the blockchain node 104 for proof that the target transaction exists in a target block. The transaction representation may be obtained in a different way, e.g. directly from the blockchain or from a different party, e.g. Bob 103b. Alice 103a may also receive (e.g. from the blockchain node 104) an indication of the hash functions that parameterise the Bloom filter.

From the perspective of the blockchain node 104, the blockchain node 104 may send the transaction representation to one or more users, e.g. in response to receiving a request for proof that a particular transaction (e.g. the target transaction) exists. The blockchain node 104 may send, to one or more users, e.g. Alice 103a, some or all of the set of transactions that make up a block, e.g. the block comprising the target transaction.

The following provides more information on the transaction representation, which will now be denoted as [symbol] . A Bloom filter is a probabilistic data structure used to query whether a data value x′ᵢ is a member of a data set {x₁, x₂, . . . , xₙ}. It is an array with m entries, each containing a binary digit to record the mappings of input data to the respective outputs of k hash functions, where k is a parameter of the bloom filter.

At first, the bloom filter contains m entries indexed in the range [1:m] containing binary digits [0:1] all set to zero. When each transaction is hashed by all k hash functions, the zero bits in the corresponding arrays are substituted by a one bit instead.

A benefit of Bloom filters is that they are an efficient technique of querying if a transaction is included in the set of a chosen block provided the probability of a false positive, p, occurring is relatively small. The probability of a false positive, p, occurring is dependent on the number of transactions n, the size of the bloom filter m, the number of hash functions k as shown in the equation below:

$$p = ( 1 - {e}^{- \frac{kn}{m}} ) .$$

For a given ratio m/n the optimum value of k is given by the following equation

$${k}_{opt} = ( log 2 ) \cdot \frac{m}{n} .$$

For the optimum value of k the false positive rate is given by:

$$p = {( \frac{1}{2} )}^{{k}_{opt}} = {( \frac{1}{{2}^{log 2}} )}^{m / n} .$$

Given n and the required false positive rate p, the required array size m can be found using the equation below

$$m = \frac{n log p}{log ( \frac{1}{{2}^{log 2}} )}$$

Which can be altered when required. The more transactions used, given a fixed Bloom filter size m and a fixed number of hashes k, the higher the probability of a false positive occurring. This is because as the number of transactions increases, the bits in the bloom filter fill up. This can be prevented by increasing the size of the bloom filter which would be at the expense of storage size.

To test if the transaction Txᵢ, is a member of the transaction set used to create [symbol] , where i refers to the index of transaction that is being checked, the steps below are taken:
i. Hash Txᵢ with all k hash functions to obtain outputs is in the range [1:m].
ii. Check the buckets corresponding to the output of each hash function.

If the corresponding buckets all contain a ‘1’ (i.e. a value of 1), then we conclude that Txᵢ is a member of the set of transactions included in the block, with false positive probability given by p above. If any of the hash outputs correspond to arrays containing a 0 then Tᵢ is certainly not a member of the block.

### 9. Low-Burden Blockchain

Section 7 explained that, in general, there are two broad approaches taken to achieve scalability for a blockchain project; namely ‘layer-2 scaling’ and ‘big-block scaling’. In the case of the latter, a large block size and space for transactions is considered vital because the scalability approach is conventionally based on economic actors (i.e. ‘miners’) competing to meet the ever-growing hardware and capital expenditure demands to validate and mine new blocks. This in turn means that there is little need to optimise the use of block space, which may have the effect of reducing certain functionalities such as complex scripting and data-carriage.

Conversely, the layer-2 scaling approach shifts the burden of processing high volumes of transactions to a second layer of economic actors, such that the base blockchain (i.e. layer-1) can be held, validated and maintained by anybody. This requires that the layer-1 blockchain is low-burden and thus there is a necessity to optimise the design of the layer-1 blockchain such that its burden on a user/validator/miner is minimised.

In general, blockchains, such as the BTC blockchain, that aim to utilise a layer-2 scaling approach still contain historical artefacts of the original Bitcoin design, which does not feature such optimisations, such as the use of Merkle trees for encoding information about the transactions in each block.

This section describes an optimised low-burden blockchain (LBB) architecture for a layer-1 blockchain seeking to scale using the layer-2 scaling principle. Some or all of the following features may be implemented by the blockchain node 104 and blockchain network 106 of the system 700 described with reference to FIG. 7.

### Blockchain Design

The low-burden blockchain has an optimally minimalistic data model comprising, at a high level, the following components:
Blocks; and
Transactions.

These are the basic functional units required to construct and use the LBB, where each transaction represents an event that occurs on the LBB and blocks are simply timestamped collections of these transactions.

### Blocks

The blocks in the LBB data model comprise a block header and a set [symbol] of n+1 transactions Tx_{CB}, Tx₁, Tx₂, . . . , Txₙ, where Tx_{CB} is a privileged coinbase transaction paying a block reward to a miner. The block header for the i^{th} block of the LBB contains the following fields of information:
Previous block hash ϕᵢ₋₁,
Nonce v; and
Transaction representation [symbol] .

The block hash ϕᵢ of the i^{th} block, which can be used to uniquely identify the i^{th} block, is computed using a cryptographic hash function and is defined by the equation:

$${ϕ}_{i} := H ( {ϕ}_{i - 1} \vert \vert v \vert \vert ) ,$$

where H is a cryptographic hash function, and [symbol] is a representation of the set of transactions [symbol] . Note that in an alternative case, a miner key Pₘ may be included as part of the block header instead of the coinbase transaction.

There is no strict need for ‘block headers’ in this low-throughput system because we do not need to cater to two different classes of actor, where systems such as Bitcoin include block headers to help cater for both miners and users using simplified payment verification (SPV).

The system has a low enough barrier to becoming a processor that all users and mining nodes alike can reasonably handle all transactions in a block, without needing to distinguish between them in terms of hardware, processing, and resource requirements. When we refer to a ‘block header’ in the LBB framework, we are simply referring to the data elements that constitute a block other than the transactions themselves.

| Header | → | ϕᵢ | | | | |
|---|---|---|---|---|---|---|
| hash | | | | | | |
| Block | → | ϕᵢ₋₁ | R_{T} | v | Additional | |
| header | | | | | information | |
| Tx_{CB} | → | | | Pₘ | Reward | |
| Tx₁ | → | I₁ | P₁ⁱⁿ | P₁^{out} | V₁ | Sig P₁ⁱⁿ |
| Tx₂ | → | I₂ | P₂ⁱⁿ | P₂^{out} | V₂ | Sig P₂ⁱⁿ |
| . | → | . | . | . | . | . |
| . | | . | . | . | . | . |
| . | | . | . | . | . | . |
| Txₙ | → | Iₙ | Pₙⁱⁿ | Pₙ^{out} | Vₙ | Sig Pₙⁱⁿ |

The initial transaction is a coinbase transaction where the reward paid to the miner is specified, which includes the standard fee that each transaction pays to be placed into a block. This miner key Pₘ may also be part of the block header to save space with the reward being a standard that is constant per block. We may interpret any minted coins or transaction fees associated with that block as being controlled by the owner of the miner key, which may be subject to any economic model, issuance schedule, and transaction fee policy that is required on a particular instance of an LBB. The coinbase can also be used as additional nonce space.

### Transactions

The transactions in the LBB model are a simplified version of transactions seen in other blockchains, and can be mapped to both UTXO-based and account-based systems. In embodiments, an LBB transaction comprises at least the following:
Index—1 byte (allows for up to 256 transactions per block)
Input address—32 bytes
Output address—32 bytes
Value—4 bytes
Input Signature—70 bytes

Using the above values, the expected size of an LBB transaction is approximately 140 bytes. The average size of a corresponding (i.e. P2PKH) transaction in Bitcoin at the time of writing is 193 bytes. Therefore the number of transactions per unit of block space (measured in bytes) is significantly higher in the LBB model than in the Bitcoin model, representing a significant throughput and efficiency improvement.

Transaction identifiers (TxIDs) may also be used in an LBB to uniquely identify each transaction recorded on the blockchain. This may be done similarly to Bitcoin by taking the double-hash of the serialised transaction data TxIDᵢ=SHA256d(Txᵢ). However, it should be noted that the uniqueness of these transaction IDs will depend on the precise implementation details of the transactions. For example, if a UTXO-based model is used, the uniqueness may be assured in a similar manner to Bitcoin by also including previous outpoints, which are themselves unique, in the transactions shown in the table above. Alternatively, if an account-based model is used, then a nonce for each account/public key may be introduced to ensure uniqueness of each TxID.

### Life-Cycle of a Transaction

A transaction in an LBB system will be involved in different process during its life-cycle, and at each different point we can consider the impact of its low-burden property in the context of that process. The life-cycle and corresponding low-burden considerations are as follows:
Creation—when a transaction is created, there is no direct advantage of the LBB system, but the process may be expedited if transaction creation requires checking previous associated transactions (e.g. verifying the state of an ‘account’) due to the low number of transaction throughput.
Validation—when a transaction is validated by a node, the overhead may be reduced compared with Bitcoin if the transaction validation is dependent on checking the existence of previous transactions due to the minimised throughput of transactions.
Mining—when a candidate block is constructed, the LBB design has the benefit of reducing the overhead due to the choice of [symbol] where the value n per block is low. This offers a lower operational cost of block construction that is incurred by miners/nodes of an LBB system.
Proof of existence—when an end user of an LBB wants to check the integrity or validity of a transaction, they can perform a proof of existence. Such a proof is a way of proving that the transaction of interest is part of the transaction set of a given block, and will typically involve proving that this transaction is a member of the set represented by [symbol] . Due to the choice of [symbol] , the proof of existence process will represent lower overheads than the Merkle proofs used in Bitcoin, either in terms of data sizes or number of computations, assuming low n.

### Block Production

The block production process is similar to that of Bitcoin, but differs slightly depending on the choice of transaction representation [symbol] in the system. This is because the choice of [symbol] will affect the process required to generate the specific [symbol] for a given block. The steps involved in constructing a block, regardless of the choice of [symbol] are as follows:
i. Receive transactions Tx₁, Tx₂, . . . , Txₙ.
ii. Validate transactions Tx₁, Tx₂, . . . , Txₙ.
iii. Calculate [symbol] for set of valid transactions.
iv. Add [symbol] to the block header ϕᵢ.
v. Input ϕᵢ into the LBB consensus algorithm.

It should be noted that the block production process is agnostic to the particular consensus algorithm chosen for a particular LBB.

### Transaction Validation

Step ii. in the block production process relates to validating transactions. This step may have multiple sub-processes associated with it, which are not detailed here. For example, in Bitcoin this step will involve:
Checking the syntax of each transaction is correct,
Checking that each transaction has output value(s) less than or equal to input value(s), and
Validating scripts using the Bitcoin script engine.

The specifics of transaction validation will depend on the particular implementation of an LBB and any additional rules that may be imposed in said implementation. However, it should be noted that the complexity of the validation step of block production will impact the overheads and required resources associated with block production.

### 10. Conclusion

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of constructing a candidate block of a blockchain, wherein the method comprises:
obtaining a set of blockchain transactions;
obtaining a transaction representation by inputting each of the set of blockchain transactions to a Bloom filter that utilizes one or more hash functions; and
constructing the candidate block, wherein the candidate block comprises the transaction representation.

The transaction representation is the final state of the Bloom filter once each transaction has been input to the Bloom filter. Inputting a transaction to the Bloom filter comprises hashing the transaction with one or more hash functions and recording the output with a set of binary digits.

Statement 2. The method of statement 1, wherein the candidate block comprises the set of blockchain transactions

Statement 3. The method of statement 1 or statement 2, comprising submitting the candidate block to a blockchain network for inclusion in the blockchain.

Statement 4. The method of any preceding statement, comprising:
making the transaction representation available to one or more users.

Statement 5. The method of statement 4, wherein said making of the transaction representation available to the one or more users comprises sending the transaction representation available to the one or more users.

Statement 6. The method of statement 4 or statement 5, wherein said making of the transaction representation available to the one or more parties comprises is in response to receiving, from a verifying user, a request for a proof-of-existence of a target blockchain transaction.

Statement 7. The method of statement 4 or any statement dependent thereon, comprising:
making one, some or all of the set of blockchain transactions available to the one or more users.

Statement 8. The method of statement 6 and statement 7, wherein said making of the one, some or all of the set of blockchain transactions available to the one or more users comprises making the target blockchain transaction available to the verifying user.

Statement 9. The method of statement 6 or statement dependent thereon, comprising:
informing the verifying party of the one or more hash functions utilized by the Bloom filter.

Statement 10. The method of any preceding statement, comprising:
making one or more of the set of blockchain transactions available to one or more blockchain nodes.

Statement 11. The method of statement 10, wherein said making of the one or more of the set of blockchain transactions available to the one or more blockchain nodes comprises sending the one or more of the set of blockchain transactions blockchain nodes.

Statement 12. The method of any preceding statement, wherein the candidate block comprises a block header used to link the block to a previous block of the blockchain, and wherein the block header comprises the transaction representation.

Statement 13. The method of statement 12, wherein the block header comprises a hash of the respective block header of the previous block and a nonce value, such that when the block header is hashed, the resulting hash of the block header satisfies a predetermined difficulty target.

Statement 14. The method of any preceding statement, wherein the set of blockchain transactions comprises a coinbase transaction.

A coinbase transaction may also be referred to as a generation transaction.

Statement 15. The method of any preceding statement, comprising:
assigning each of the set of blockchain transactions a respective index.

Statement 16. The method of statement 15, comprising:
explicitly recording the respective index of each of the set of blockchain transactions in the candidate block.

Statement 17. The method of any preceding statement, wherein said obtaining of the set of blockchain transactions comprises receiving at least some of the set of blockchain transactions from one or more users.

Statement 18. The method of any preceding statement, wherein said obtaining of the set of blockchain transactions comprises receiving at least some of the set of blockchain transactions from one or more nodes of the blockchain network.

Statement 19. A computer-implemented method of determining whether a block of a blockchain comprises a target blockchain transaction, wherein the block comprises a transaction representation obtained by inputting each of a set of blockchain transactions to a Bloom filter that utilizes one or more hash functions, and wherein the method comprises:
obtaining the target blockchain transaction;
obtaining a target representation of the target blockchain transaction by inputting the target blockchain transaction to each of the one or more hash functions utilized by the Bloom filter; and
determining whether the block comprises the target blockchain transaction based on a comparison of the transaction representation and the target representation.

Statement 20. The method of statement 19, wherein said obtaining of the target blockchain transaction comprises obtaining the target blockchain transaction from one or more nodes of the blockchain network.

Statement 21. The method of statement 19 or any statement dependent thereon, wherein said obtaining of the target blockchain transaction comprises obtaining the target blockchain transaction from one or more users.

Statement 22. The method of statement 19 or any statement dependent thereon, comprising obtaining the transaction representation from one or more nodes of the blockchain network.

Statement 23. The method of statement 22, comprising transmitting, to the one or more nodes, a request for a proof-of-existence of the target blockchain transaction, and wherein said obtaining of the transaction representation is in response to said transmitting of the request.

Statement 24. The method of statement 19 or any statement dependent thereon, comprising:
obtaining an indication of the one or more hash functions utilized by the Bloom filter.

Statement 25. The method of statement 24, wherein said indication is obtained from one or more nodes of the blockchain network.

Statement 26. The method of statement 19 or any statement dependent thereon, wherein said determining of whether the block comprises the target blockchain based on a comparison of the transaction representation and the target representation comprising performing a set membership test for the target transaction on the transaction representation.

Statement 27. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 26

Statement 28. A computer program embodied on computer-readable storage and configured so as, when run on one or more processors, to perform the method of any of statements 1 to 26.

According to another aspect disclosed herein, there may be provided a method comprising the actions of the blockchain node and the verifying party.

According to another aspect disclosed herein, there may be provided a system comprising the computer equipment of the blockchain node and the verifying party.

1. A computer-implemented method of constructing a candidate block of a blockchain, wherein the method comprises:
obtaining a set of blockchain transactions;
obtaining a transaction representation by inputting each of the set of blockchain transactions to a Bloom filter that utilizes one or more hash functions; and
constructing the candidate block, wherein the candidate block comprises the transaction representation.

2. The method of claim 1, wherein the candidate block comprises the set of blockchain transactions

3. The method of claim 1, comprising submitting the candidate block to a blockchain network for inclusion in the blockchain.

4. The method of claim 1, comprising:
making the transaction representation available to one or more users.

5. The method of claim 4, wherein said making of the transaction representation available to the one or more users comprises sending the transaction representation available to the one or more users.

6. The method of claim 4, wherein said making of the transaction representation available to the one or more users comprises in response to receiving, from a verifying user, a request for a proof-of-existence of a target blockchain transaction.

7. The method of claim 4, comprising:
making one, some or all of the set of blockchain transactions available to the one or more users.

8. The method of claim 6, wherein said making of the one, some or all of the set of blockchain transactions available to the one or more users comprises making the target blockchain transaction available to the verifying user.

9. The method of claim 6, comprising:
informing the verifying party of the one or more hash functions utilized by the Bloom filter.

10. The method of claim 1, comprising:
making one or more of the set of blockchain transactions available to one or more blockchain nodes.

11. The method of claim 10, wherein said making of the one or more of the set of blockchain transactions available to the one or more blockchain nodes comprises sending the one or more of the set of blockchain transactions blockchain nodes.

12. The method of claim 1, wherein the candidate block comprises a block header used to link the block to a previous block of the blockchain, and wherein the block header comprises the transaction representation.

13. The method of claim 12, wherein the block header comprises a hash of the respective block header of the previous block and a nonce value, such that when the block header is hashed, the resulting hash of the block header satisfies a predetermined difficulty target.

14. The method of claim 1, wherein the set of blockchain transactions comprises a coinbase transaction.

15. The method of claim 1, comprising:
assigning each of the set of blockchain transactions a respective index.

16. The method of claim 15, comprising:
explicitly recording the respective index of each of the set of blockchain transactions in the candidate block.

17. (canceled)

18. The method of claim 1, wherein said obtaining of the set of blockchain transactions comprises receiving at least some of the set of blockchain transactions from one or more nodes of the blockchain network.

19. A computer-implemented method of determining whether a block of a blockchain comprises a target blockchain transaction, wherein the block comprises a transaction representation obtained by inputting each of a set of blockchain transactions to a Bloom filter that utilizes one or more hash functions, and wherein the method comprises:
obtaining the target blockchain transaction;
obtaining a target representation of the target blockchain transaction by inputting the target blockchain transaction to each of the one or more hash functions utilized by the Bloom filter; and
determining whether the block comprises the target blockchain transaction based on a comparison of the transaction representation and the target representation.

20-26. (canceled)

27. Computer equipment comprising:
memory comprising one or more memory units; and
processing apparatus comprising one or more processing units, wherein the memory stores code arranged to run on the processing apparatus, the code being configured so as when on the processing apparatus to perform a method of constructing a candidate block of a blockchain, wherein the method comprises:
obtaining a set of blockchain transactions;
obtaining a transaction representation by inputting each of the set of blockchain transactions to a Bloom filter that utilizes one or more hash functions; and
constructing the candidate block, wherein the candidate block comprises the transaction representation.

28. A computer program embodied on non-transitory computer-readable storage media and configured so as, when run on one or more processors, the one or more processors perform a method of constructing a candidate block of a blockchain, wherein the method comprises:
obtaining a set of blockchain transactions;
obtaining a transaction representation by inputting each of the set of blockchain transactions to a Bloom filter that utilizes one or more hash functions; and
constructing the candidate block, wherein the candidate block comprises the transaction representation.
